(19) United States
(12) Patent Application Publication
(10) Pub. No.: US 2026/0194006 A1
(43) Pub. Date: Jul. 9, 2026

(54) ACOUSTIC PANEL FOR AN AIRCRAFT TURBOMACHINE, AND ASSOCIATED METHOD AND INSTALLATION

(71) Applicants: SAFRAN, Paris (FR); SAFRAN NACELLES, Gonfreville-L'Orcher (FR)

(72) Inventors: Patrick DUNLEAVY, MOISSY-CRAMAYEL (FR); Sophie SENANI, MOISSY-CRAMAYEL (FR); Denis GUILLOIS, MOISSY-CRAMAYEL (FR)

(73) Assignees: SAFRAN, Paris (FR); SAFRAN NACELLES, Gonfreville-L'Orcher (FR)

(21) Appl. No.: 18/869,978

(22) PCT Filed: Jun. 1, 2023
(86) PCT No.: PCT/FR2023/050766

§ 371 Date: Nov. 27, 2024

(30) Foreign Application Priority Data
Jun. 3, 2022 (FR) FR2205369

(51) Int. Cl. F02C 7/045

(52) U.S. Cl. CPC F02C 7/045; F05D 2220/323; F05D 2230/90; F05D 2250/283; F05D 2260/963; F05D 2300/603

(57) ABSTRACT

An acoustic panel for an aircraft turbomachine. The acoustic panel includes a first skin formed from a first composite material having a first polymer matrix and reinforcing fibers embedded in the matrix, a second skin formed from a second composite material having a second, thermoplastic polymer matrix and reinforcing fibers embedded in the second matrix, and a core having a honeycomb structure The core can be arranged between the first skin and the second skin, and the second skin can contain holes having a diameter less than 1 mm.

### TECHNICAL FIELD OF THE INVENTION

The invention relates to the field of acoustic panels for aircraft turbomachines, and in particular for the aircraft turbomachine nacelles.

The invention also relates to the manufacture of these acoustic panels.

### TECHNICAL BACKGROUND

The prior art is illustrated by the documents U.S. Pat. No. B2-6,609,592, EP-A1-2 821 621, US-A 1-2019/337632, and US-A1-2021/324794.

An aircraft turbomachine comprises, for example, from upstream to downstream in the direction of gas flow along a longitudinal axis, a fan, a low-pressure compressor and a high-pressure compressor, a combustion chamber, a high-pressure turbine and a low-pressure turbine and a gas exhaust nozzle.

The fan allows the suction of an air flow divided into a primary flow and a secondary flow. The primary flow passes through a primary duct of the turbomachine while the secondary flow is directed towards a secondary duct surrounding the primary duct.

The primary flow is compressed in the compressors. The compressed air is then mixed with a fuel and burned within the combustion chamber. The gases resulting from the combustion pass through the turbines then escape through the nozzle whose cross-section allows the acceleration of these gases to generate the propulsion.

The fan typically comprises a disc movable in rotation about the longitudinal axis and blades mounted on the disc. The blades are surrounded by a fan casing centered on the longitudinal axis and configured to retain the blades in the event of damage, for example to the blades.

The fan casing is typically surrounded by a nacelle that allow to protect the fan. A fan of this type is said to be ducted, as opposed to unducted fans whose blades are not surrounded by a casing.

The turbomachines, and in particular the fans, are a major source of noise pollution, and there is a strong demand to reduce this type of pollution. To this end, it has been proposed that the nacelles be fitted with acoustic panels so as to reduce the noise generated by the turbomachine fans.

An acoustic panel typically comprises a sandwich structure comprising first and second skins, and between which is arranged a core having a honeycomb structure configured to absorb the sound waves. The first skin is attached to the casing of the fan and the second skin is in contact with the secondary flow. The second skin typically has holes to allow sound waves to propagate into the core through which they are absorbed. The holes formed in the second skin are generally larger than 1 mm in diameter.

Although it significantly reduces the noise pollution generated by the turbomachine, this type of acoustic panel is not entirely satisfactory. The second skin is the radially inner skin, i.e. the skin radially closest to the longitudinal axis, and the first skin is the radially outer skin, i.e. the skin radially furthest from the longitudinal axis. The second skin is therefore in contact with the secondary air flow and is a factor in the aerodynamic performance of the turbomachine. The holes provided in this second skin tend to increase the drag and reduce the aerodynamic performance of the turbomachine. However, these holes are necessary for sound waves to pass through the acoustic panel and be absorbed. As a result, the noise reduction is currently achieved at the expense of the aerodynamic performance of the turbomachine.

There is therefore a need to provide an acoustic panel for an aircraft turbomachine that has good acoustic insulation performance while minimizing the drag in order to preserve the aerodynamic performance of the turbomachine.

### SUMMARY OF THE INVENTION

To this end, the invention proposes an acoustic panel for an aircraft turbomachine, the acoustic panel comprising:
a first skin formed from a first composite material having a first polymer matrix and reinforcing fibers embedded in the matrix,
a second skin formed from a second composite material having a second thermoplastic polymer matrix and reinforcing fibers embedded in the second matrix, and
a core having a honeycomb structure, the core being arranged between the first skin and the second skin, the second skin comprising holes having a diameter of less than 1 mm.

The acoustic panel is remarkable in that it comprises a coating comprising a layer comprising a ceramic material and deposited by thermal spraying, the first skin being arranged between the coating and the core.

According to the invention, the acoustic panel comprises a second skin with holes having a diameter of less than 1 mm.

It was found that a second skin with holes of this diameter significantly reduced the aerodynamic drag of the turbomachine without affecting the acoustic insulation quality of the acoustic panel. Thanks to the invention, it is therefore possible to reduce noise pollution from the turbomachine while preserving the aerodynamic performance of the turbomachine. In addition, according to the invention, the second skin is made of a composite material with a thermoplastic polymer matrix. The polymer matrix allows the holes with a diameter of less than 1 mm to be made without damaging the second skin. In fact, it has been found that certain drilling methods used to produce small-diameter holes are not compatible with all materials. For example, laser drilling holes requires the use of a matrix that may withstand temperatures in excess of 300° C. The thermosetting polymer matrices do not withstand such high temperatures and drilling holes with a diameter of less than 1 mm in such matrices tends to degrade the second skin around the drilling area, reducing the quality of the acoustic panel.

The invention therefore allows to provide an acoustic panel with good acoustic and aerodynamic properties.

The acoustic panel according to the invention may comprise one or more of the following characteristics, taken in isolation from each other or in combination with each other:
the diameter of the holes is between 0.1 mm and 0.8 mm, preferably between 0.3 mm and 0.8 mm,
the second skin has a thickness of less than 1 mm, advantageously between 0.5 mm and 0.8 mm,
the second polymer matrix has a melting temperature above 300° C., preferably above 400° C.,
the coating further comprises an additional layer of glass fibers, arranged between the layer and the first skin,
the additional layer comprises a first sub-layer of non-woven glass fibers and a second sub-layer of woven glass fibers,
a stiffener,
the stiffener comprises a frame comprising walls arranged on edges of the second skin and/or studs arranged on the second skin.

The invention also relates to a method for manufacturing an acoustic panel according to any of the preceding characteristics, the method comprising the following steps:
(100) forming the second skin by automatic fiber placement,
(102) making the holes on the second skin,
(104) forming the core by additive manufacturing on the second skin, and
(106) forming the first skin by additive manufacturing on the core.
(108) depositing the layer of the coating onto the first skin by thermal spraying.

The method may comprise one or more of the following characteristics, taken alone or in combination with each other:
the holes are produced by laser drilling.

The invention also relates to an installation for manufacturing an acoustic panel according to any of the preceding characteristics, comprising:
a first station for manufacturing the second skin comprising:
   an unwinder for strips comprising the fibers impregnated in the thermoplastic polymer matrix,
   a roller for compacting the strips,
   a device for heating the strips, and
   a member for drilling the second skin,
a second station for manufacturing the core and the first skin, comprising an additive manufacturing device,
a third station for manufacturing the coating, the third station comprising a thermal spraying device.

### BRIEF DESCRIPTION OF THE FIGURES

Further characteristics and advantages will be apparent from the following description of a non-limiting embodiment of the invention with reference to the appended drawings wherein:

FIG. 1 is a schematic representation of an aircraft turbomachine in longitudinal cross-section,

FIG. 2 is a schematic perspective view of an acoustic panel according to the invention,

FIG. 3 is a schematic perspective view of an example of embodiment of a core of the acoustic panel,

FIG. 4 is a block diagram of a method for manufacturing an acoustic panel according to the invention,

FIG. 5 is a schematic representation of an installation for manufacturing an acoustic panel according to the invention,

FIG. 6 is a partial schematic representation of a manufacturing station for the second skin.

### DETAILED DESCRIPTION OF THE INVENTION

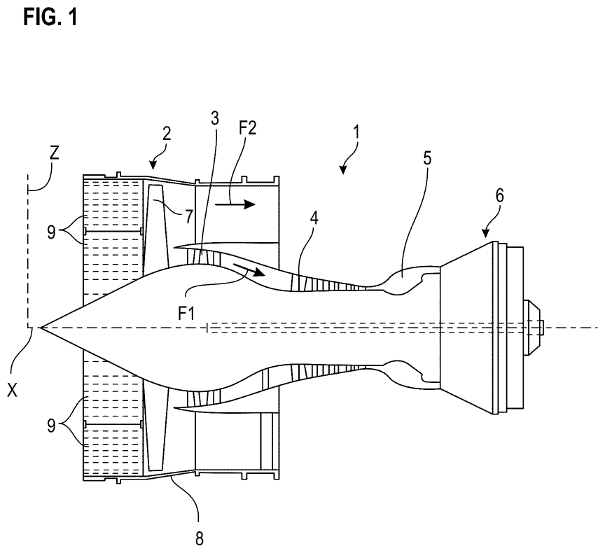

An example of a turbomachine 1 for an aircraft is shown in FIG. 1. The turbomachine 1 extends around and along a longitudinal axis X.

In this application, the terms “upstream”, “downstream”, “axial” and “axially” are defined in relation to the direction of gas flow in the turbomachine along the longitudinal axis X.

The terms “radial”, “radially”, “internal”, “internal”, “external”, “external”, “externally”, are defined in relation to a radial axis Z which is perpendicular to the longitudinal axis X and in relation to the distance from the longitudinal axis X along the radial axis Z.

The turbomachine 1 comprises, from upstream to downstream, a fan 2, at least one compressor such as a low-pressure compressor 3 and a high-pressure compressor 4, a combustion chamber 5, at least one turbine 6 such as a high-pressure turbine and a low-pressure turbine, and a nozzle.

The fan 2 allows the suction of an air flow dividing into a primary flow F1 and a secondary flow F2. The primary flow F1 passes through the engine of the turbomachine 1, while the secondary flow F2 is directed towards a secondary duct.

The primary flow F1 is compressed in the low-pressure compressor 3 and then in the high-pressure compressor 4. The compressed air is then mixed with a fuel and burned within the combustion chamber 5. The gases formed by combustion pass through the high-pressure and low-pressure turbines. The gases escape finally through the nozzle whose cross-section allows the acceleration of these gases to generate the propulsion.

The fan 2 comprises a disc movable in rotation about the longitudinal axis X and blades 7 mounted on the disc. The blades 7 extend radially from the disc. The blades 7 are surrounded by a casing 8. The casing 8 is centered on the longitudinal axis X. In addition, a nacelle (not shown) is arranged around the casing 8, coaxially and attached to the latter.

In order to reduce the noise pollution generated by the turbomachine 1, the turbomachine 1 also comprises at least one acoustic panel 9 attached to the inside of the casing 8. Generally, several acoustic panels 9 are attached inside the casing 8. The acoustic panels 9 have a complex shape that allows them to be adapted to the shape of the casing 8. Each acoustic panel 9 extends over an angular sector, for example.

Each acoustic panel 9 is able to absorb an acoustic energy over a frequency range of between 100 Hz and 1500 Hz.

Each acoustic panel 9 advantageously forms a monolithic part.

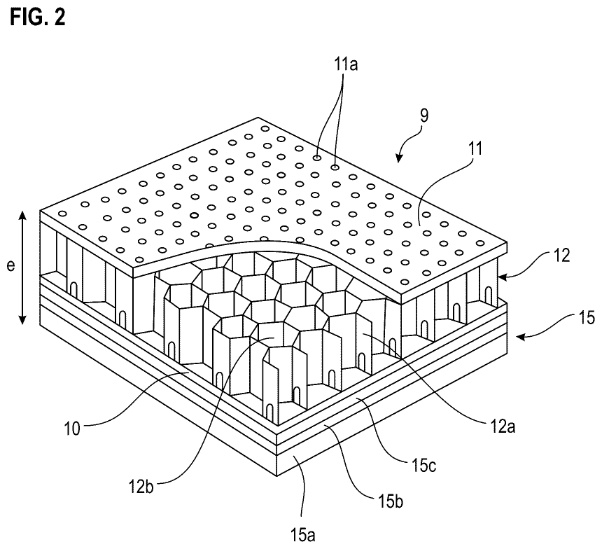

With reference to FIG. 2, each acoustic panel 9 has a thickness e of between 10 mm and 50 mm. This thickness provides a good acoustic insulation without increasing the drag.

Each acoustic panel 9 has a sandwich structure. Each acoustic panel 9 comprises a first skin 10, a second skin 11 and a core 12 arranged between the first skin 10 and the second skin 11. Advantageously, the second skin 11 and the first skin 10 are substantially parallel.

When the acoustic panel 9 is mounted in the casing 8, the first skin 10 is located outside the second skin 11. Advantageously, the second skin 11 forms the innermost skin.

The first skin 10 is made of a first composite material with a first polymer matrix and reinforcing fibers embedded in the matrix. The polymeric material of the first matrix is chosen, for example, from thermoplastics such as polyolefins, for example polyethylene or polypropylene, or thermosets such as epoxies.

The reinforcing fibers are chosen from carbon, glass and polyamide fibers, for example.

The carbon fibers are, for example, polyaryletherketone (PAEK) fibers such as polyetherketone (PEK), polyetheretherketone (PEEK) or polyetherketoneketone (or PEKK), or polyacrylonitrile (PAN) fibers such as HexTow@ AS4, AS7 or IM7 fibers marketed by Hexcel.

Advantageously, the fibers are continuous fibers, i.e. rovings made up of assemblies of parallel or twisted continuous filaments.

Advantageously, the fibers are high-strength fibers and/or have an intermediate modulus, for example a modulus of between 200 GPa and 250 GPa.

For example, the first skin 10 has a thickness of between 0.5 mm and 2 mm, preferably between 0.8 mm and 2 mm.

The first skin 10 is advantageously produced by additive manufacturing.

The second skin 11 is made of a second composite material. The second composite material comprises a second polymer matrix selected from thermoplastics and reinforcing fibers embedded in the second matrix.

The thermoplastic material of the second matrix may be the same as or different from the thermoplastic material of the first polymer matrix. The thermoplastic of the second matrix is for example chosen from polyolefins such as polyethylene, polypropylene or fluorinated polymers or polyamides or polyaryletherketones such as polyetheretherketone (PEEK).

Advantageously, the second matrix has a melting temperature above 300° C., preferably above 400° C. and even more preferably between 400° C. and 500° C., preferably between 420° C. and 480° C.

The reinforcing fibers are chosen from carbon, glass and polyamide fibers, for example.

The carbon fibers are, for example, polyaryletherketone (PAEK) fibers such as polyetherketone (PEK), polyetheretherketone (PEEK) or polyetherketoneketone (or PEKK), or polyacrylonitrile (PAN) fibers such as HexTow@ AS4, AS7 or IM7 fibers marketed by Hexcel.

Advantageously, the fibers are continuous fibers, i.e. rovings made up of assemblies of parallel or twisted continuous filaments.

Advantageously, the fibers are high-strength fibers and/or have an intermediate modulus, for example a modulus of between 200 GPa and 250 GPa.

The reinforcing fibers may be identical to or different from the reinforcing fibers in the first skin 10.

The second skin 11 is formed by the automatic fiber placement method. This allows the second skin 11 to be manufactured automatically.

The second skin 11 has holes 11a. The holes 11a are through holes. They pass through the entire thickness of the second skin 11. According to the invention, the holes 11a have a diameter of less than 1 mm, advantageously between 0.1 mm and 0.8 mm and even more advantageously between 0.3 mm and 0.8 mm. The diameter of the holes 11 a allows to reduce the aerodynamic drag of the turbomachine 1. The second skin 11 is in contact with the secondary flow F2 and its presence causes an aerodynamic drag which reduces the performance of the turbomachine 1. It has been found that holes 11a of this size considerably reduce this drag.

The holes 11a have a circular cross-section, for example.

The holes 11a are made by laser drilling or mechanical drilling. The advantage of laser drilling is that holes with a diameter of less than 1 mm may be made in the shaped second skin 11 automatically, thereby considerably reducing the time and cost of manufacturing the acoustic panel 9. Also, as the second matrix is made of thermoplastic, the laser drilling does not damage the second skin 11, unlike thermosetting materials, which may not withstand the temperatures used during laser drilling.

Advantageously, the second skin 11 is less than 1 mm thick, preferably between 0.5 mm and 0.8 mm.

The core 12 is arranged between the first skin 10 and the second skin 11. The core 12 has a honeycomb structure. The core 12 comprises honeycomb cells 12a. Each honeycomb cell 12a, for example, has a hexagonal or triangular cross-section. The cross-section of the alveolar cells 12a may differ from one alveolar cell 12a to another. Each alveolar cell 12a is hollow and has an internal cavity 12b which communicates with at least one hole 11a. This allows each honeycomb cell 12a to absorb some of the acoustic energy emitted by the fan 2.

Advantageously, the core 12 comprises a superposition of honeycomb cells 12a. The core 12 comprises, for example, a first lap of honeycomb cells 12a and a second lap of honeycomb cells 12a (not shown). The first and second laps are separated by a septum. In the present technical field, a septum is a perforated membrane that is transparent to certain frequency ranges and impermeable to other frequency ranges. This configuration of the core 12 allows the acoustic panel 9 to absorb sound energy over a wider frequency range.

The first lap allows to absorb sound energy in a first frequency range, while the second lap allows to absorb sound energy in another frequency range. In addition, thanks to the diameter of the holes 11a, it is possible to increase the height of the acoustic panel 9 to absorb the acoustic energy over a wide range of frequencies without increasing the drag.

Generally speaking, the greater the height of the panel, the greater the aerodynamic drag. The core 12 is made, for example, of a metallic material such as aluminum or a polymeric or composite material. The core 12, for example, is made from the same material as the first skin 10.

The core 12 is advantageously produced by additive manufacturing directly on the second skin 11. In this way, the manufacture of the acoustic panel 9 according to the invention may be fully automated without any manual assembly steps.

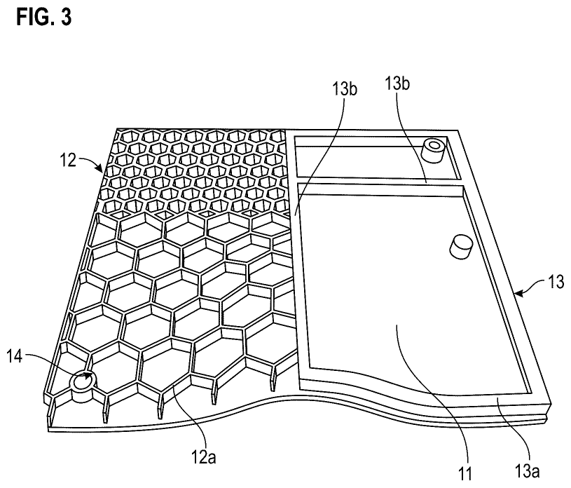

With reference to FIG. 3, the acoustic panel 9 advantageously comprises a stiffener and preferably a plurality of stiffeners. The stiffeners allow to stiffen the acoustic panel 9. This allows to reduce the risk of the acoustic panel 9 collapsing.

The stiffeners comprise, for example, a frame 13 and/or studs 14.

Advantageously, the frame 13 is arranged on the second skin 11. The frame 13 is square or rectangular, for example. The frame 13 comprises walls 13a arranged on edges, advantageously the four edges of the second skin 11, and spacers 13b arranged inside the walls 13a. The height of the frame 13, for example, is approximately equal to the height of the honeycomb cells 12a.

The studs 14 are arranged on the second skin 11 and between the alveolar cells 12a. The studs 14 have a circular cross-section, for example. The height of the studs 14 is advantageously equal to the height of the alveolar cells 12a. The studs 14 have an internal bore, for example. So, as well as giving stiffness to the acoustic panel 9, the studs 14 allow the acoustic panel 9 to be attached to the casing 8 by means of fastening screws (not shown) passing through the studs 14 and attached to the casing 8.

Preferably, the acoustic panel 9 also comprises a coating 15 arranged on the first skin 10.

The first skin 10 is thus arranged between the core 12 and the coating 15. The coating 15 comprises a layer 15a comprising a ceramic material and preferably comprising a majority of a ceramic material and even more preferably consisting of a ceramic material. The ceramic material comprises, for example, yttriated zyrcone, silica and alumina. The layer 15a allows to improve the fire resistance and thermal insulation of the acoustic panel 9.

The layer 15a is deposited by thermal spraying, for example.

To further improve the insulating properties of the coating 15, the latter also comprises an additional layer of glass fiber. The additional layer is arranged between the layer 15a of ceramic material and the first skin 10.

The additional layer comprises, for example, a first sub-layer 15b, for example made of non-woven glass fibers, and a second sub-layer 15c, for example made of woven glass fibers or thermoplastic, to promote adhesion to the first skin 10. The second sublayer 15c is arranged between the first sublayer 15b and the first skin 10. The second sublayer 15c is applied, for example, by wet surface treatment such as dipping or spraying.

The coating 15, for example, has a thickness of between 0.2 mm and 5 mm.

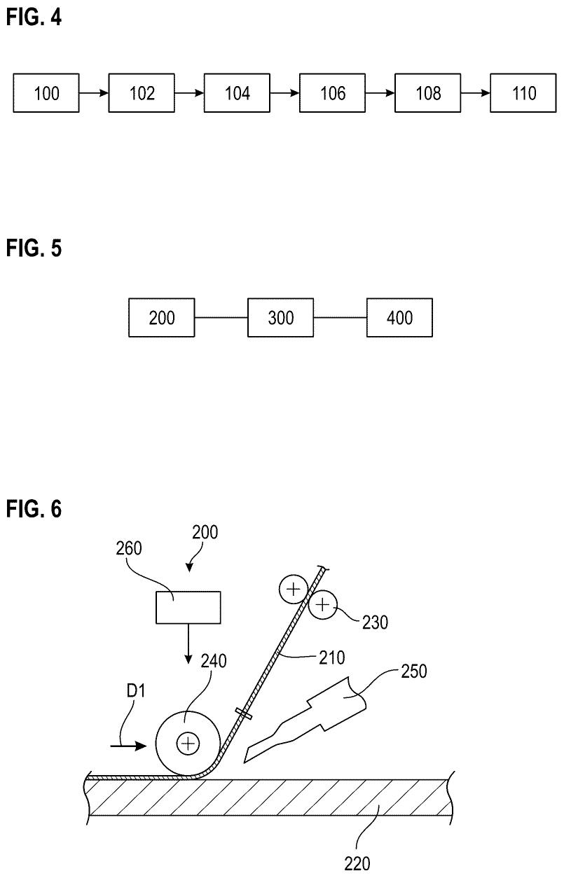

A method for manufacturing the acoustic panel 9 will now be described with reference to FIG. 4. The method comprises a first step 100 of forming the second skin 11 by automatic fiber placement. During this first step 100, several strips 210 of pre-impregnated fibers are deposited on a support 220. The strips 210 are then compacted and heated to favor the strips 210 to adhere to each other. The heating temperature of the strips 210 is between 400° C. and 500° C., preferably between 400° C. and 450° C., even more preferably 420° C.

Then, in a second step 102, the holes 11a are made in the second skin 11. During this second step 102, the second skin 11 is drilled by mechanical or laser drilling.

The laser drilling is particularly advantageous in that it allows small-diameter holes to be made in the shaped second skin 11 without damaging the second skin 11, the matrix of which is made of a thermoplastic polymer material.

The laser drilling, for example, is carried out using a laser. The laser is, for example, a short or ultra-short pulse power laser. Advantageously, the laser generates radiation with a wavelength of between 1 nm and 1 mm. The radiation generated is therefore in the infrared, visible or ultraviolet range.

Then, in a third step 104, the core 12 is formed by additive manufacturing on the second skin 11. The core 12 is therefore formed directly on the second skin 11. No additional assembly steps are required. The core 12 is formed, for example, by fused filament fabrication (FFF).

Then, in a fourth step 106, the first skin 10 is formed by additive manufacturing on the core 12. The first skin 10 is therefore formed directly on the core 12. No additional assembly steps are required. The first skin 10 is formed, for example, using the FFF (Fused Filament Fabrication) technique.

Then, in an optional fifth step 108, the coating 15 is deposited on the first skin 10. In a first sub-step, the additional layer is deposited on the first skin 10 and then the ceramic layer 15a is deposited by thermal spraying.

Finally, in an optional sixth finishing step 110, the acoustic panel 9 is machined.

According to the invention, the manufacturing method for manufacturing the acoustic panel 9 is fully automated, which allows to reduce the manufacturing time of the acoustic panel 9 and considerably reduces costs. In addition, the quality of the holes 11a in terms of shape and size, thanks to the laser drilling method, allows to provide an acoustic panel 9 with remarkable acoustic performance and a low drag.

An installation for the manufacturing of acoustic panel 9 will now be described with reference to FIGS. 5 and 6.

The installation comprises a first station 200 for manufacturing the second skin 11 and a second station 300 for manufacturing the core 12 and the first skin 10.

The first station 200 is shown in FIG. 6, for example. The first station 200 comprises an unwinder 230 for strips 210 of fiber pre-impregnated in the second thermoplastic polymer matrix. The unwinder 230 allows to deposit the strips 210 on the support 220.

The first station 200 also comprises a compacting roller 240. The compacting roller 240 allows to apply a pressure to the strips 210 placed on the support 220 so as to encourage the adhesion between the strips 210. The compacting roller 240 may be moved in translation along the strips 210 in direction D1. This allows a pressure to be applied along the entire length of the strips 210 to favor the strips 210 to adhere to each other along their entire length.

The first station 200 also comprises a device for heating 250 the strips 210. The heating device 250 allows to heat the strips 210 as they are deposited on the support 220. This allows to favor the strips 210 to adhere to each other by melting the thermoplastic matrix. The combination of the pressure and of the temperature therefore favors the strips to adhere to each other. The heating temperature is between 400° C. and 500° C., preferably between 400° C. and 450° C., even more preferably 420° C. The heating device 250 is, for example, a laser such as an infrared laser.

The first station 200 also comprises a member 260 for drilling the second skin 11. The drilling member 260 is, for example, a laser or a mechanical drill. The laser is, for example, a short or ultra-short pulse power laser. Advantageously, the laser generates radiation with wavelength of between 1 nm and 1 mm. The radiation generated is therefore in the infrared, visible or ultraviolet range.

The second station 300 for manufacturing the core 12 and the first skin 11 comprises an additive manufacturing device (not shown). The additive manufacturing device comprises, for example, a first filament dispenser, a first extruder and a fused filament fabrication plate.

According to another example of embodiment, and in particular when the core 12 and the first skin 10 are manufactured from different materials, the additive manufacturing device also comprises a second filament dispenser and a second extruder.

The installation may also comprise a third station 400 for manufacturing the coating 15. The third station 400 comprises a thermal projection device. The thermal spraying device comprises, for example, a torch for spraying a powder comprising a ceramic material, preferably a predominantly ceramic material, via a carrier gas.

The installation described in this invention therefore allows the acoustic panel 9 to be manufactured in-line without manual intervention.

1. An acoustic panel for an aircraft turbomachine, the acoustic panel comprising:
a first skin formed from a first composite material having a first polymer matrix and reinforcing fibers embedded in the first polymer matrix;
a second skin formed from a second composite material having a second thermoplastic polymer matrix and reinforcing fibers embedded in the second thermoplastic polymer matrix, the second skin comprising holes having a diameter less than 1 mm;
a core having a honeycomb structure, the core being arranged between the first skin and the second skin; and
a coating having a layer comprising a ceramic material and deposited by thermal spraying, wherein the first skin is arranged between the coating and the core.

2. The acoustic panel according to claim 1, wherein the diameter of the holes is between 0.1 mm and 0.8 mm,

3. The acoustic panel according to claim 1, wherein the second skin has a thickness less than 1 mm.

4. The acoustic panel according to claim 1, wherein the second polymer matrix has a melting temperature above 300° C.

5. The acoustic panel according to claim 1, wherein the coating further comprises an additional layer of glass fibers arranged between the layer and the first skin.

6. The acoustic panel according to claim 5, wherein the additional layer comprises a first sub-layer of non-woven glass fibers and a second sub-layer of woven glass fibers.

7. The acoustic panel according to claim 1, further comprising a stiffener.

8. The acoustic panel according to claim 7, wherein the stiffener comprises a frame including walls arranged on edges of the second skin and/or studs arranged on the second skin.

9. A method for manufacturing an acoustic panel according to claim 1, the method comprising:
forming the second skin by automatic fiber placement;
making the holes on the second skin;
forming the core by additive manufacturing on the second skin;
forming the first skin by additive manufacturing on the core;
depositing the layer of the coating onto the first skin by thermal spraying.

10. The method according to claim 9, wherein the holes are produced by laser drilling.

11. An installation for manufacturing an acoustic panel according to claim 1, the installation comprising:
a first station for manufacturing the second skin comprising:
an unwinder for strips comprising the fibers impregnated in the second thermoplastic polymer matrix;
a roller for compacting the strips;
a device for heating the strips; and
a member for drilling the second skin;
a second station for manufacturing the core and the first skin, comprising an additive manufacturing device; and
a third station for manufacturing the coating, wherein the third station comprises a thermal spraying device.

12. The acoustic panel according to claim 1, wherein the diameter of the holes is between 0.3 mm and 0.8 mm

13. The acoustic panel according to claim 3, wherein the thickness is between 0.5 mm and 0.8 mm.

14. The acoustic panel according to claim 4, wherein the melting temperature is above 400° C.
